(19) United States
(12) Patent Application Publication
(10) Pub. No.: US 2012/0158447 A1
(43) Pub. Date: Jun. 21, 2012

(54) PRICING BATCH COMPUTING JOBS AT DATA CENTERS

(75) Inventor: Navendu Jain, Bellevue, WA (US)

(73) Assignee: MICROSOFT CORPORATION, Redmond, WA (US)

(21) Appl. No.: 12/973,399

(22) Filed: Dec. 20, 2010

(51) Int. Cl. G06Q 10/00

(52) U.S. Cl. 705/7.15; 705/7.13

(57) ABSTRACT

This document describes techniques for pricing batch computing jobs based at least in part on temporally- or spatially-dependent costs. By so doing, prices offered to perform a batch computing job better reflect the costs to perform that batch computing job.

### BACKGROUND

Modern data centers perform countless batch computing jobs for businesses and individual users. A modern data center, for example, may enable tens of thousands of individuals to browse the Internet or perform operations using extensive computational resources.

Providers of data-center services often rent computational resources based on the amount of resources requested by these businesses or individuals. Thus, from the buyer's perspective, the price to perform batch computing jobs is generally proportional to the resources requested, such as computational resources used per hour and the like. These pricing models, however, fail to adequately reflect costs, timeliness of the computation, and balancing supply vs. demand, among other factors, to perform the batch computing jobs.

### SUMMARY

This document describes techniques for pricing batch computing jobs based at least in part on temporally- or spatially-dependent costs. By so doing, prices offered to perform a batch computing job better reflect the costs to perform that batch computing job.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit of a reference number identifies the figure in which the reference number first appears. The use of the same reference number in different instances in the description and the figures may indicate similar or identical items.

FIG. 1 illustrates an environment in which techniques for pricing batch computing jobs at data centers can be employed.

FIG. 2 is a flow diagram depicting an example process for enabling selection of multiple prices for a batch computing job.

FIG. 3 illustrates an example user interface presenting three selectable prices for three completion times for a batch computing job.

FIG. 4 illustrates example temporally-dependent electricity costs for a first data center and on which a price for completing a batch computing job can be based.

FIG. 5 illustrates example temporally-dependent electricity costs for a second data center and on which a price for completing a batch computing job can be based.

FIG. 6 is a flow diagram depicting an example process for determining multiple prices for a batch computing job based on parameters of the batch computing job, temporally- and/or spatially-dependent electricity costs, other varying costs, and/or additional pricing factors.

FIG. 7 illustrates example information received, and prices determined by, a price module of FIG. 1.

FIG. 8 illustrates a user interface enabling selection of a batch computing job, a parameter for that batch computing job, and a penalty associated with not performing the batch computing job on time.

### DETAILED DESCRIPTION

### Overview

This document describes techniques for pricing batch computing jobs at data centers based at least in part on temporally- or spatially-dependent costs. A modern data center includes an infrastructure, such as a building, wiring, air conditioners, and security systems, as well as information technology, such as many hundreds to tens of thousands of computer servers, memory, networking, storage, and backup systems. While these capital expenditure aspects of the modern data center are expensive, energy costs are fast becoming the majority of many data centers' total operational costs. Current pricing of batch computing jobs, however, often fails to adequately take into account these energy costs and other varying costs.

Assume, for example, that a provider of data-center resources offers to perform batch computing jobs at a set price based on resource usage within a set amount of time. If a data center is out of resources, or an electricity provider has insufficient or high-cost electricity within the amount of time, the provider may lose money in performing the batch computing job. These are but two of many possible factors affecting costs to perform a batch computing job at a data center, others of which are

### Example Environment

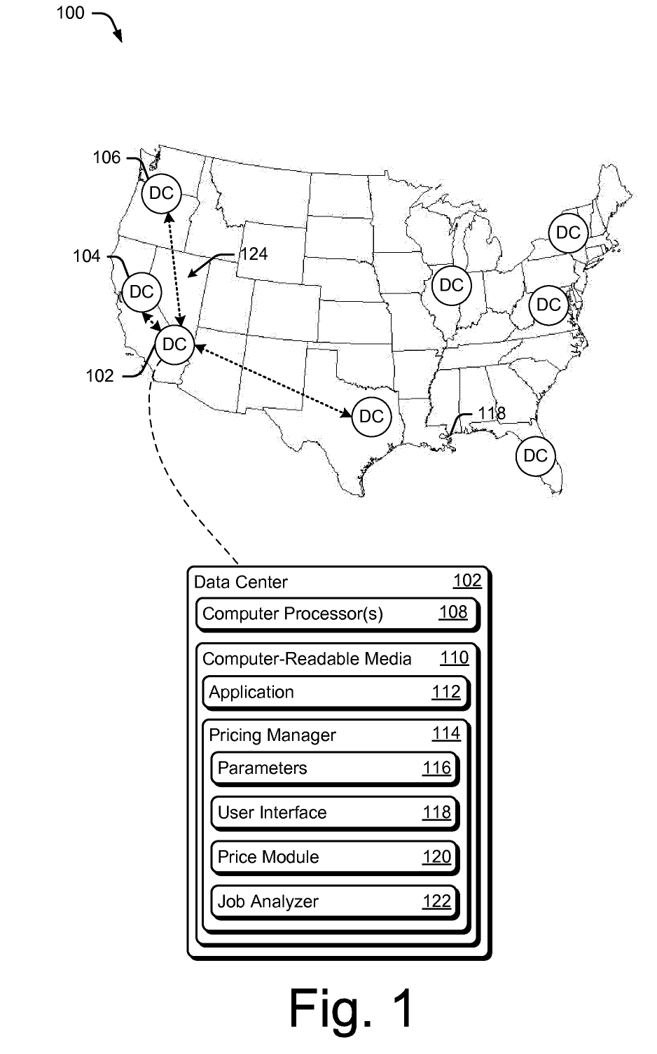

FIG. 1 is an illustration of an example environment 100 in which techniques for pricing batch computing jobs at data centers can be embodied. Environment 100 includes data centers 102, 104, and 106, as well as other, unmarked data centers. The data centers include computer processor(s) 108 and computer-readable media 110 (as well as infrastructure and other aspects omitted for brevity). Computer-readable media includes an application 112 capable of performing a batch computing job or, in some cases, that is effectively the same as the batch computing job. One of the data centers either includes, has access to, or receives instructions from a pricing manager 114. Thus, pricing manager 114 may or may not be operating at a data center.

Pricing manager 114 enables selection of prices based on a batch computing job requested and varying costs to perform that job at one or more of the data centers (e.g., 102, 104, 106, or others). Pricing manager 114 includes parameters 116 for a requested batch computing job that may affect costs to perform the batch computing job, a user interface 118 in which to enable selection of prices and other information, a price module 120 to calculate a cost and price to perform the batch computing job, and a job analyzer 122 to determine one or more of parameters 116 of the batch computing job that may affect costs.

The illustrated data centers are capable of communicating with each other and entities requesting batch computing jobs, such as through the Internet, shown in three cases at 124 with dashed lines between data center 102 and data centers 104, 106, and one unmarked data center. While all of the data centers may both use the Internet 124 or other communication network(s), bandwidth costs (costs to transfer information) and network latency (time to transfer information) may vary substantially, not only generally but also at certain times.

One or more of the entities shown in FIG. 1 may be further divided, combined, and so on. Thus, environment 100 illustrates some of many possible environments capable of employing the described techniques. Generally, any of the techniques and abilities described herein can be implemented using software, firmware, hardware (e.g., fixed-logic circuitry), manual processing, or a combination of these implementations. The entities of environment 100 generally represent software, firmware, hardware, whole devices or networks, or a combination thereof. In the case of a software implementation, for instance, the entities (e.g., pricing manager 114, application 112) represent program code that performs specified tasks when executed on a processor (e.g., processor(s) 108). The program code can be stored in one or more computer-readable memory devices, such as computer-readable media 110. The features and techniques described herein are platform-independent, meaning that they may be implemented on a variety of commercial computing platforms having a variety of processors. Ways in which entities of data centers 102, 104, and/or 106 act are set forth in greater detail below.

### Example Processes

The following discussion describes processes for pricing batch computing jobs at data centers. Aspects of these processes may be implemented in hardware, firmware, software, or a combination thereof. These processes are shown as sets of blocks that specify operations performed, such as through one or more entities or devices, and are not necessarily limited to the order shown for performing the operations by the respective blocks. In portions of the following discussion reference may be made to environment 100 of FIG. 1.

Process 200 and 600 are described below. Process 200 addresses temporally- and spatially-dependent electricity costs at data centers and prices based on one or more of these as well as a completion time for a batch computing job. Process 600 addresses parameters of the batch computing job and how these parameters may affect costs and prices.

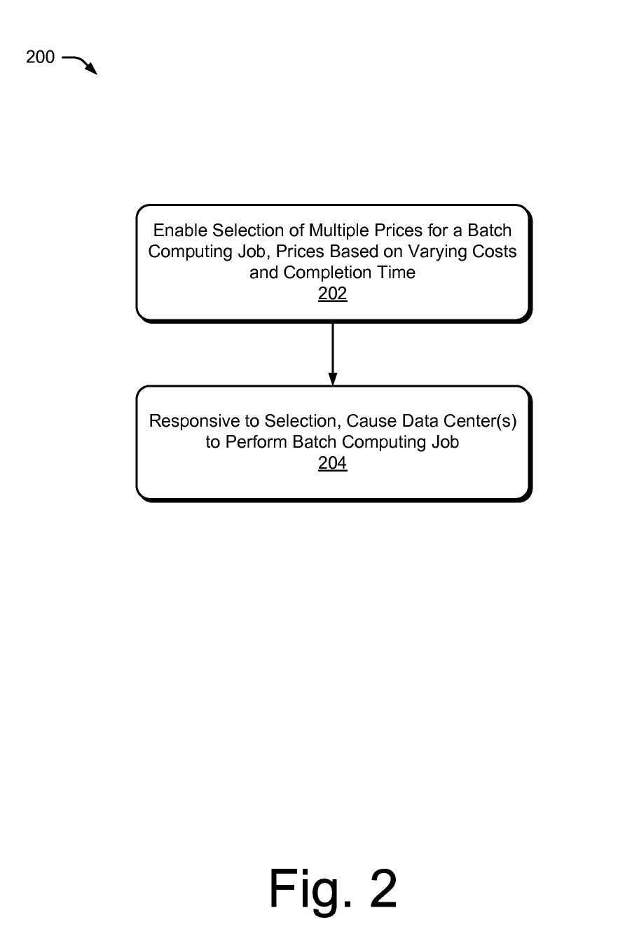

FIG. 2 is a flow diagram depicting an example process 200 for enabling selection of multiple prices for a batch computing job and, responsive to selection, causing the batch computing job to be performed at one or more data centers.

Block 202 enables selection of multiple prices to perform a batch computing job at one or more data centers, the prices based on varying costs and completion time. These varying costs are based at least in part on temporally-dependent electricity costs or spatially-dependent electricity costs at the one or more data centers, which vary based on the completion time. Completion times offered with these prices may depend on a user's selection and/or low-cost-point times, such as times that reflect relatively low costs compared to other times. Other varying costs and factors, as well as costs affected by parameters for the batch computing job, may also affect these multiple prices. These other costs and parameters are described in greater detail in later portions of the description.

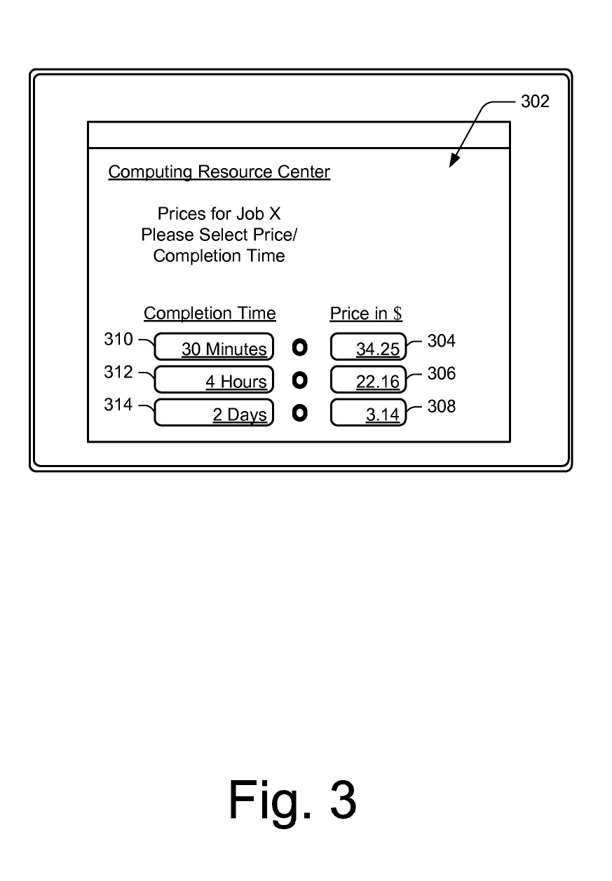

By way of example, consider FIG. 3, which illustrates a user interface 302 presenting three prices 304, 306, and 308 to complete a batch computing job within three different times, shown at 310, 312, and 314, respectively. A user may select to have the batch computing job performed at these three different prices based on the completion time for each. Other possible examples include presenting many prices or presenting prices responsive to a user selecting the completion time. This selection of a completion time can include presenting a data-entry field for entry of a completion time or a slider bar having a completion time of nearly immediate to days or even weeks. These are a few of many possible pricing interfaces and techniques and are not intended to be exhaustive.

These example, selectable prices are based on varying electricity costs at one or more data centers. By way of example, consider first a relatively simple case of two data centers having temporally-dependent electricity and spatially-dependent electricity costs but excluding many other factors described later below.

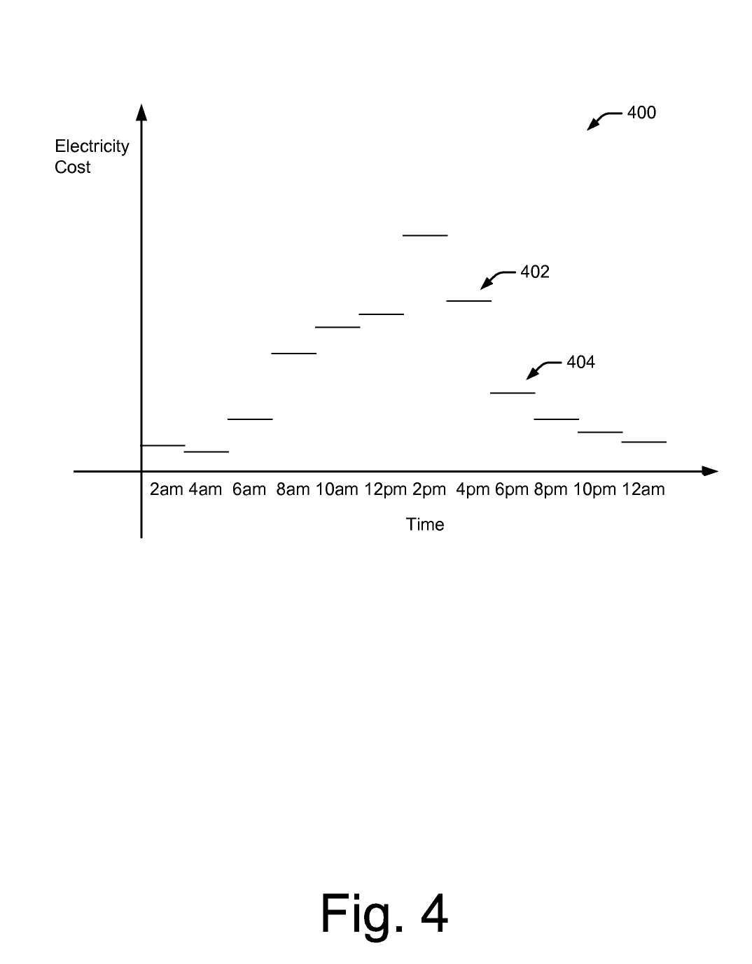

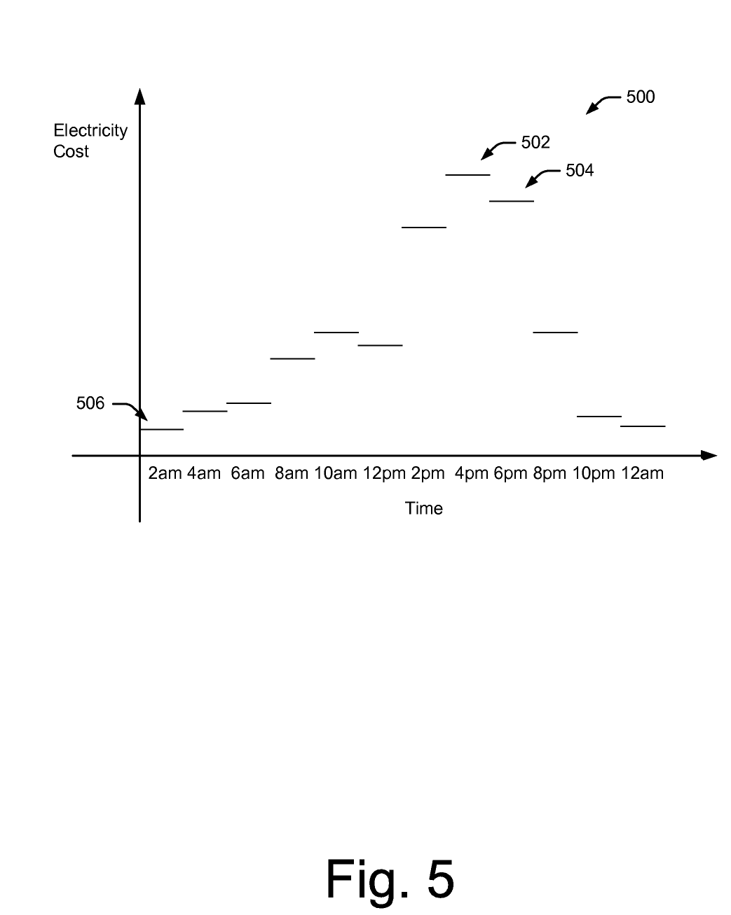

FIGS. 4 and 5 illustrate electricity costs over a 24-hour period for data centers 102 and 104, respectively. Electricity costs are shown per two-hour period over 24 hours at 400 for data center 102 and 500 in FIG. 5 for data center 104. These are simplified examples, as electricity costs may vary in different manners and/or more often, such as in 15-minute periods.

As shown, these data centers 102, 104 have different electricity costs at different times of the day, such as periods marked as 4 pm (which cover from 4 pm to 6 pm). Note that for data center 104, the electricity cost shown at 502 is much higher than the electricity cost at 402 for data center 102 for the same period.

This information shown in FIGS. 4 and 5 can be used to determine selectable prices to perform a batch computing job based on completion time for either or both of temporally- and spatially-dependent electricity costs.

Consider the three different completion times shown in FIG. 3 at user interface 302. For the first completion time, namely 30 minutes, assume that latency, capacity, or bandwidth factors preclude data center 102 from performing the batch computing job. Thus, in this case graph 500 of FIG. 5 is used to determine price 304 but graph 400 of FIG. 4 is not. Nonetheless, this graph 500 still provides temporally-dependent electricity costs on which the price for completing the batch computing job can be based.

Assume that prices for the batch computing job are requested at 4:15 pm, responsive to which pricing manager 114 enables selection of three prices for three different completion times. For the quickest time, 30 minutes, pricing manager 114 bases the price of $34.25 on the temporally-dependent electricity costs to perform the batch computing job at just data center 104 and during the 4 pm to 6 pm period (which, as illustrated, is the most expensive of the day), shown at 502.

For the second price 306 of $22.16, assume that both electricity costs of data center 102 and 104 are considered. Thus, price 306 is based on both temporally-dependent electricity costs and spatially-dependent electricity costs because the price now depends on electricity costs that vary because of two different data centers being in different locations, namely southern and central California (which have different electricity costs). Note that prices for electricity costs are still high until 6 pm at both data centers 102 and 104, but that they fall at 6 pm for data center 102 shown at 404 in FIG. 4, but remain high at data center 104, shown at 504. As the batch computing job is likely allocated to data center 102, latency and bandwidth costs are considered. Thus, this price may be based on electricity costs at the 6 pm-to-8 pm period shown at 404, as well as costs to transmit data to perform, and the results of, the batch computing job between data center 102 and the requesting entity.

Continuing this relatively simple example, assume that pricing manager 114 bases the third, and relatively low, price based on electricity costs to perform the batch computing job at the 2 am-to-4 am period for data center 104, shown at 506 in FIG. 5.

Returning to FIG. 2, block 204, responsive to selection by the requesting entity, causes one or more data centers to perform the batch computing job within the selected completion time. Concluding the above example, pricing manager 114 causes the batch computing job to be performed by data center 104 within 30 minutes, or data center 102 within 4 hours, or data center 104 within two days.

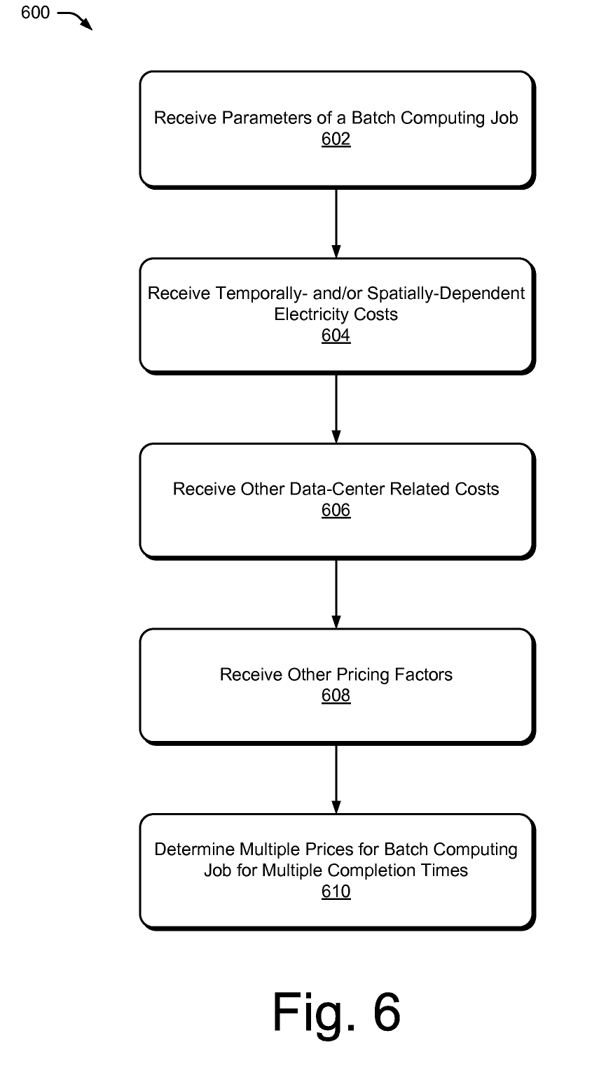

FIG. 6 is a flow diagram depicting an example process 600 for determining multiple prices for a batch computing job based on parameters 116 of the batch computing job, temporally- and/or spatially-dependent electricity costs, other varying costs, and/or additional pricing factors.

Block 602 receives parameters of a batch computing job. Receiving these parameters can be responsive to selection of the parameters by a requesting entity, or may be determined by analyzing the selected batch computing job.

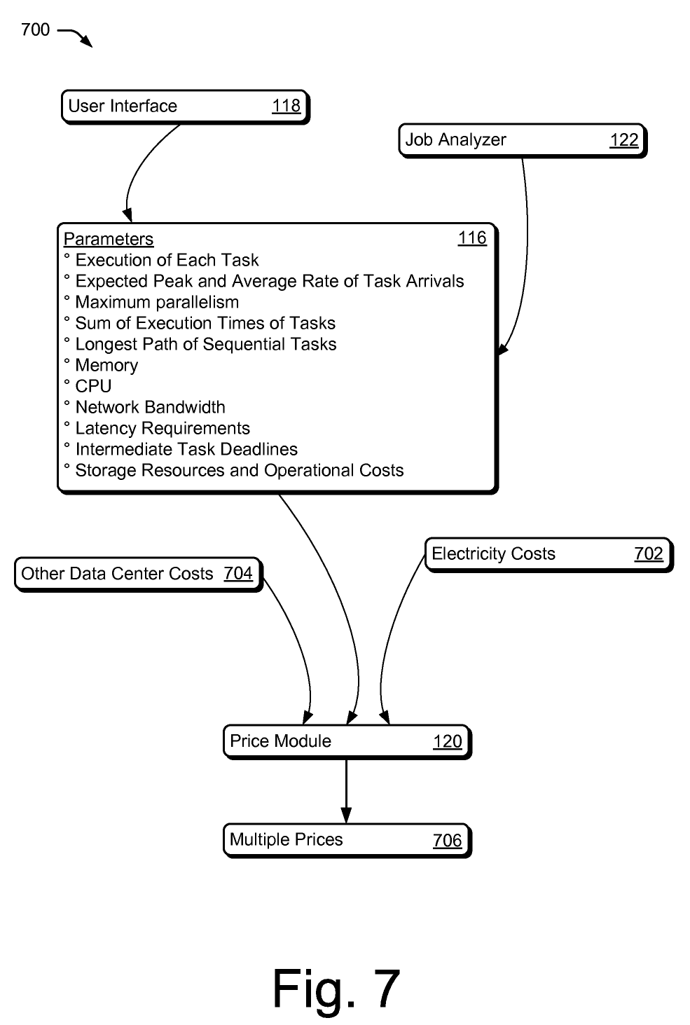

This is illustrated in part in FIG. 7, which shows parameters 116 and other information received by price module 120 of pricing manager 114 in graphic form at diagram 700 from various example sources—user interface 118 (e.g., parameters received from requesting entity) or job analyzer 122 (e.g., parameters determined based on analysis of the batch computing job).

These parameters 116 concern the batch computing job itself and potentially affect costs to perform the batch computing job. This example batch computing job, as is often the case for batch computing jobs requested to be performed by one or more data centers, includes multiple tasks. Some of these tasks can be performed in parallel and some must be performed in series. Further, the rate of task arrivals, including peak and average, may affect costs. Further still, the longest path of sequential tasks (those required to be in series) and a sum of execution times of tasks can be considered. The sum of execution times of tasks is the total amount of computing resources to perform all of the tasks of the batch computing job (often represented in CPU resource units per time units).

Still other parameters may be considered, such as the maximum parallelism of the tasks. The higher the maximum parallelism, the more a batch computing job may be spread over multiple computing resources and/or data centers. Thus, if all of the tasks of a batch computing job can be performed in parallel (thus, no sequential tasks), the tasks can be spread to as many computing resources as the data centers have available. This generally reduces the expected costs of performing a batch computing job, as it is more likely to permit execution within a period of low-cost electricity, permits moving tasks around to under-utilized computing resources, and the like. Conversely, a long path of sequential tasks may cost more to perform.

Further still, other parameters 116 for a batch computing job may be received or determined, such as memory, CPU, network bandwidth, latency requirements, and deadlines for intermediate tasks in a job (e.g., some tasks need to be performed by time X but the full job takes time X+Y) to aid in incremental processing. Storage resources and operational costs associated with a batch computing job can also be considered.

Assume, for example, that pricing manager 114 presents a user interface through which the batch computing job and some parameters of the batch computing job can be selected. Other parameters of the batch computing job are determined based on an analysis of the batch computing job, such as from job analyzer 122 (which as noted may be local or remote to pricing manager 114 and data center 102). Job analyzer 122 may determine these parameters in various manners, such as based on a history concerning performance of similar or identical batch computing jobs, or a database having parameters about similar or identical batch computing jobs.

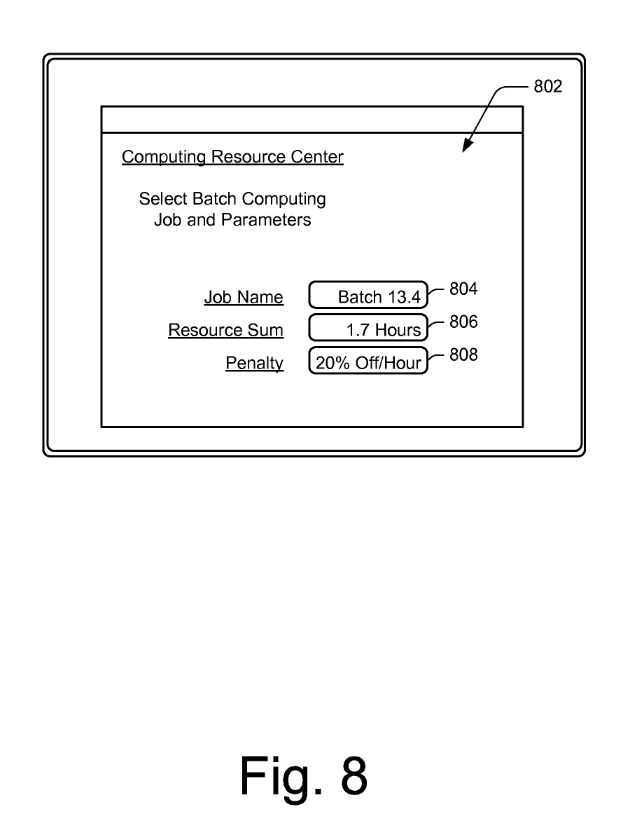

Consider, for example, FIG. 8, which illustrates user interface 802 including selection of a batch computing job and a parameter for that job. Here user interface 118 of pricing manager 114 provides user interface 802 having selectable batch computing jobs (here by drop down list or text-entry into a data entry field) shown at 804. User interface 802 also enables selection of a parameter for the batch computing job, namely an expected sum of computing resources for all tasks of the batch computing job at 806. User interface 802 also enables selection of another pricing factor, here a price reduction or penalty, which is not a parameter of the batch computing job, but rather is permission from the selecting entity to the data center provider to complete the batch computing job later than the selected time if the price for the batch computing job is reduced by a certain amount per amount of time. This penalty or reduction is handled and calculated by pricing manager 114, and is but one type of factor that may be selected that affects prices offered to complete a batch computing job.

Returning to process 600, block 604 receives temporally- and/or spatially-dependent electricity costs. Examples of these are set forth above and illustrated in FIGS. 4 and 5. Thus, price module 120 receives information on electricity costs as well as parameters. This is shown in FIG. 7 with price module 120 receiving electricity costs 702.

Block 606 receives other data-center related costs. These other costs are not specifically temporally- or spatially-dependent electricity costs but are costs on the data-center side that may affect a total cost to perform a batch computing job. Example costs include those associated with a data center's efficiency, either generally, or specifically to take on that batch computing job. Thus, a data center may be more efficient than usual in some situations and less efficient in others. At near-full capacity, for example, performing a batch computing job may disproportionally increase cooling or information technology operational costs. Other example costs include bandwidth costs to transmit data between data centers and/or a requesting entity, such as a bandwidth cost to perform some tasks of a batch computing job at a distant data center and others at a local data center (a data center close to the requesting entity). These bandwidth costs, moreover, may vary over time for each data center, further complicating cost calculations.

Latency, which is a measure of how much time it takes to send data between entities, may also be a factor. Thus, for a quick-turnaround of a batch computing job, the amount of time to send tasks to, and receives results from, a data center in New England for a requesting entity in southern California may increase costs by forcing some tasks to be done at a more-local, but higher-cost data center. Still other costs include a data center's availability, such as those due to temporally-varying demand (e.g., current or near-term demand, such as jobs requesting by other entities) and temporally-varying supply of computing resources (e.g., scheduled downtime, breakdowns, lack of network connectivity, or lack of electricity due to grid-supplied or renewably-sourced failures). Receipt of these other data centers costs is shown at 704 in FIG. 7.

Block 608 receives other pricing factors. These other factors are those that do not fit into the categories of information received at blocks 602, 604, and 606. One example includes the above-mentioned price reduction or penalty selected at 808 in FIG. 8.

Other factors affecting price include tasks of a batch computing job that do not need to be performed until after the completion time, that can be suspended (or sped up) without affecting the results of performing the batch computing job, that can be stopped and re-executed later without affecting the results of performing the batch computing job, and that may be migrated between data centers thereby affecting bandwidth costs and electricity-cost savings associated with that migration.

Thus, price module 120 may forgo performing some tasks without delaying results, such as cleaning up a database, checking for post-execution errors, archiving data, and the like. If these tasks can wait to be performed until after providing results at a completion time (this completion time being a results time but not a complete performance of the batch computing job), the batch computing job may cost less to complete.

Price module 120 may suspend or speed up some tasks, such as by suspending and recording a checkpoint of a task's state and resuming the task a later point, or by stopping a task and re-executing the task later. Even ceasing (stopping) a task may reduce costs if the current electricity costs are higher than later costs, even if some of the task is re-performed.

Also, price module 120 may take into account bandwidth costs to migrate tasks and savings in migrating tasks to lower-cost data centers even of a same batch computing job (or even all of the job). These factors are not exhaustive, other factors, such as taxes (which may vary for each data center) and networking operations costs, may also be considered.

Block 610 determines multiple prices for performing a batch computing job at one or more data centers for multiple completion times. These prices are based on one or more of the parameters, electricity costs, other data-center costs, or other pricing factors, as well as completion times for performing the batch computing job. As noted above, completion times can be calculated to find low-cost-points, though this is not required. Low-cost-points can be those in which a batch computing job can be completed at relatively low cost compared to other times but also balancing a desire to complete a job quickly. Thus, if a cost to complete a batch computing job is just slightly more to complete in 4 hours than 6 hours, the 4-hour completion time can be offered as a low-cost point. Further, if 25 minutes is very expensive but 32 minutes is quite a bit cheaper, the 32-minute completion time can be offered based on the techniques set forth herein.

These multiple prices can be provided for selection, such as shown at 310, 312, and 314 in user interface 302. Providing these multiple prices is shown at 706 in FIG. 7. These prices are not necessarily the same, more, or less than determined costs, as profit, sale prices, and other aspects may also be considered.

### CONCLUSION

This document describes techniques for pricing batch computing jobs at data centers. These techniques enable selection of multiple prices for multiple completion times based on temporally- or spatially-dependent electricity costs. Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method comprising:
enabling selection of multiple prices to perform a batch computing job at multiple data centers, each of the multiple prices having a different completion time and based at least in part on temporally-dependent electricity costs and spatially-dependent electricity costs at the multiple data centers; and
responsive to selection, causing the multiple data centers to perform the batch computing job at or prior to the completion time associated with the selected price.

2. The computer-implemented method as recited in claim 1, wherein the batch computing job comprises tasks and each of the multiple prices is further based on:
an execution time of at least one of the tasks;
an expected peak and expected average rate of task arrivals at the multiple data centers;
a maximum parallelism of the tasks of the batch computing job;
a sum of execution times of the tasks;
memory used by the tasks;
CPU used by the tasks;
network bandwidth to transmit results of the batch computing job;
latency requirements;
storage resources and operational costs;
intermediate deadlines of the tasks of the batch computing job; or a longest path of sequential tasks needed to complete the batch computing job.

3. A computer-implemented method comprising:
enabling selection of multiple prices to perform a batch computing job at one or more data centers, each of the multiple prices having a different completion time and based at least in part on temporally-dependent electricity costs or spatially-dependent electricity costs at the one or more data centers; and
responsive to selection, causing the one or more data centers to perform the batch computing job at or prior to the completion time associated with the selected price.

4. The computer-implemented method as recited in claim 3, further comprising enabling selection of a price reduction or penalty if the one or more data centers does not perform the batch computing job at or prior to the completion time, and wherein at least one of the multiple prices is based on a selected price reduction or penalty.

5. The computer-implemented method as recited in claim 3, wherein each of the multiple prices is based on the temporally-dependent electricity costs for a single data center of the multiple data centers.

6. The computer-implemented method as recited in claim 3, wherein the multiple prices are based on the spatially-dependent electricity costs, a first of the one or more data centers having a different electricity cost than a second of the one or more data centers because the first and second data centers are spatially disparate.

7. The computer-implemented method as recited in claim 3, further comprising determining the multiple prices based on the temporally-dependent electricity costs or the spatially-dependent electricity costs at the one or more data centers.

8. The computer-implemented method as recited in claim 7, wherein determining the multiple prices is further based on temporally-dependent network communication costs or an amount of time to transmit results of performing the batch computing job.

9. The computer-implemented method as recited in claim 7, wherein the batch computing job comprises tasks and determining the multiple prices is further based on:
an execution time of at least one of the tasks;
an expected peak and expected average rate of task arrivals;
a maximum parallelism of the tasks;
a sum of execution times of the tasks;
memory used by the tasks;
CPU used by the tasks;
network bandwidth to transmit results of the batch computing job;
latency requirements;
storage resources and operational costs;
intermediate deadlines of the tasks of the batch computing job; or
a longest path of sequential tasks needed to complete the batch computing job.

10. The computer-implemented method as recited in claim 7, further comprising, prior to enabling selection, determining low-cost-point completion times based on the temporally-dependent electricity costs or the spatially-dependent electricity costs at the one or more data centers, and wherein determining the multiple prices is further based on the low-cost-point completion times.

11. The computer-implemented method as recited in claim 7, further comprising, prior to enabling selection, determining expected completion times based on availability of computational resources at the one or more data centers sufficient to perform the batch computing job, and wherein the different completion times are based on the expected completion times.

12. The computer-implemented method as recited in claim 7, wherein determining the multiple prices is further based on:
not performing, until after the completion time, a first set of tasks of the batch computing job, the first set of tasks capable of being delayed without affecting results provided by the completion time;
suspending a second set of tasks of the batch computing job, the second set of tasks capable of being suspended without affecting the results provided;
ceasing a third set of tasks of the batch computing job and re-running the third set of tasks at a later time, the third set of tasks capable of being run at the later time without affecting the results provided; or
bandwidth costs and electricity-cost savings associated with migrating a fourth set of tasks of the batch computing job from one of the one or more data centers to another of the one or more data centers.

13. The computer-implemented method as recited in claim 3, wherein the multiple prices are further based on a transfer time to provide results of performing the batch computing job from the one or more data centers to a receiver of the results.

14. The computer-implemented method as recited in claim 3, wherein the multiple prices are further based on bandwidth costs or storage costs.

15. The computer-implemented method as recited in claim 3, wherein the multiple prices are further based on spatially-varying or temporally-varying demand for computation resources at the one or more data centers.

16. The computer-implemented method as recited in claim 3, wherein the multiple prices are further based on temporally-varying supply of computational resources at the one or more data centers.

17. A computer-implemented method comprising:
receiving parameters for a batch computing job, the parameters concerning tasks of the batch computing job and affecting a cost to perform the batch computing job at one or more data centers;
receiving temporally- or spatially-dependent electricity costs associated with the one or more data centers; and
determining multiple prices to perform the batch computing job at the one or more data centers, the multiple prices based on the parameters, the temporally- or spatially-dependent electricity costs associated with the one or more data centers, and different completion times for the batch computing job.

18. The computer-implemented method as recited in claim 17, wherein the parameters include one or more of:
an execution time of at least one of the tasks;
an expected peak and expected average rate of task arrivals at the one or more data centers;
a maximum parallelism of the tasks of the batch computing job;
a sum of execution times of the tasks;
a longest path of sequential tasks needed to complete the batch computing job;
memory used by the tasks;
CPU used by the tasks;
network bandwidth to transmit results of the batch computing job; or
latency requirements.

19. The computer-implemented method as recited in claim 17, further comprising receiving bandwidth costs to transmit data between an entity set to receive results of the batch computing job and the one or more data centers, and to transmit data between two or more of the data centers.

20. The computer-implemented method as recited in claim 17, further comprising:
responsive to determining multiple prices, enabling selection of the multiple prices, each of the multiple prices having one of the different completion times; and
responsive to selection, causing the one or more data centers to perform the batch computing job at or prior to the different completion time associated with the selected price.
